(19) United States
(12) Patent Application Publication
(10) Pub. No.: US 2026/0086770 A1
(43) Pub. Date: Mar. 26, 2026

(54) METHOD AND PROCESSING DEVICE FOR NUMERICAL DATA QUANTIZATION OR NUMERICAL DATA DE-QUANTIZATION

(71) Applicant: Taiwan Semiconductor Manufacturing Company, Ltd., Hsinchu (TW)

(72) Inventors: Xiaochen PENG, Hsinchu (TW); Brian CRAFTON, Hsinchu (TW); Murat Kerem AKARVARDAR, Hsinchu (TW); Ashwin Sanjay LELE, Hsinchu (TW); Bo ZHANG, Hsinchu (TW); Win-San KHWA, Hsinchu (TW)

(73) Assignee: Taiwan Semiconductor Manufacturing Company, Ltd., Hsinchu (TW)

(21) Appl. No.: 18/927,013

(22) Filed: Oct. 25, 2024

Related U.S. Application Data
(60) Provisional application No. 63/699,626, filed on Sep. 26, 2024.

(51) Int. Cl. G06F 7/556; G06F 5/01

(52) U.S. Cl. CPC G06F 7/556; G06F 5/01

(57) ABSTRACT

In one or more aspects, a processing device for numerical data quantization includes processing circuitry configured to determine a maximum exponent from a set of exponents of a set of digital representations of a set of numbers, obtain a set of scaled exponents based on the maximum exponent, and perform one of: (i) obtain a set of quantized significands based on a set of mantissas of the set of digital representations and the set of scaled exponents, or (ii) obtain a set of quantized mantissas based on the set of mantissas. The processing circuitry is configured to output a set of quantized digital representations of the set of numbers, based on the set of quantized significands, or based on the set of quantized mantissas and the set of scaled exponents; and to output a biased exponent scaling factor based on the maximum exponent.

### PRIORITY CLAIM AND CROSS-REFERENCE

This patent application claims the benefit of U.S. Provisional Patent Application No. 63/699,626 filed on Sep. 26, 2024, the entire disclosure of which is hereby incorporated by reference.

### BACKGROUND

Recent developments in the field of electronic devices and systems include the demand for increased computational capability and capacity in order to handle complicated computational tasks, such as the training of a machine learning model and/or the inference tasks based on the machine learning model. In some applications in a machine learning model based on a neural network, the activation data and/or the weight data for a particular layer of the neural network are received and/or output as floating-point data. As the volume of the activation data and the complexity of the computations (e.g., the number of layers and/or the number of nodes at each layer of the neural network and the associated weight data) increase, the size and complexity of the corresponding processing device, including the processing circuitry and memories, increase accordingly. The cost for manufacturing such processing device, the time needed for transferring the data among the processing circuitry and memories, the power consumption of operating the processing device to execute corresponding computations, and the time needed for completing the computations also increase.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a processing device, in accordance with some embodiments.

FIG. 2A is a block diagram of a micro-scaling quantizer, in accordance with some embodiments

FIG. 2B is a block diagram of a micro-scaling de-quantizer, in accordance with some embodiments.

FIG. 3A is a process flow diagram of a numerical data quantization process flow example, in accordance with some embodiments.

FIG. 3B is a process flow diagram of a numerical data de-quantization process flow example, in accordance with some embodiments.

FIG. 4A is a process flow diagram of another numerical data quantization process flow example, in accordance with some embodiments.

FIG. 4B is a process flow diagram of another numerical data de-quantization process flow example, in accordance with some embodiments.

FIG. 5 is a flowchart of a method of numerical data quantization, in accordance with some embodiments.

FIG. 6 is a flowchart of a method of numerical data de-quantization, in accordance with some embodiments.

FIG. 7 is a block diagram of a computing device usable in conjunction with one or more embodiments, in accordance with some embodiments.

### DETAILED DESCRIPTION

The following disclosure provides many different embodiments, or examples, for implementing different features of the provided subject matter. Specific examples of components and arrangements are described below to simplify this disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, this disclosure may repeat reference numerals and/or letters in the various examples. This repetition is for simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “made of” may mean either “including” or “consisting of.” In this disclosure, the phrase “one of A, B, and C” means “A, B, and/or C” (A, B, C, A and B, A and C, B and C, or A, B and C), and does not mean one element from A, one element from B, and one element from C, unless otherwise described.

In some applications, a set of digital representations of a set of numbers in one format of a longer bit-length will be first converted to another format of a shorter bit-length in order to improve the processing efficiency without significantly sacrificing the processing accuracy. For example, a set of numerical data with each number in a 16-bit floating point format or a 32-bit floating point format may be converted to a set of quantized representations with each number in a micro-scaling format (e.g., with a bit-length of 8 bits, 6 bits, or even 4 bits). In some embodiments, the conversion from a longer bit-length format to a shorter bit-length format is referred to as a numerical data quantization process; and the conversion from a shorter bit-length format to a longer bit-length format is referred to as a numerical data de-quantization process.

In some applications, numerical data quantization and de-quantization are performed by a computing device's host controller, such as a central processing unit (CPU), a graphic processing unit (GPU), a tensor processing unit (TPU), or the like. In some embodiments, such quantization and/or de-quantization processing includes shuttling the data back and forth for quantization and/or de-quantization, which may result in substantial energy consumption and latency. In addition, the involved operations in quantization and/or de-quantization are nominally complex (e.g., logarithm, exponential calculations, and/or division operations), hence costly in terms of energy.

In some embodiments, a numerical data quantization process based on the present disclosure avoids performing the logarithm and/or exponential calculations, replaces multiplication operations in a linear space to shifting and/or addition operations in an exponential space, and replaces division operations in a linear space to subtraction operations in an exponential space. Accordingly, the computational complexity and conversion speed is improved. In some embodiments, a numerical data de-quantization process based on the present disclosure also avoids performing the logarithm and/or exponential calculations, and provides a convenient approach to convert numerical data from an exponential space back to a linear space. Accordingly, with the benefits of using a micro-scaling format as discussed above, the results can still be obtained in the linear space without unduly increasing the computational complexity and conversion costs.

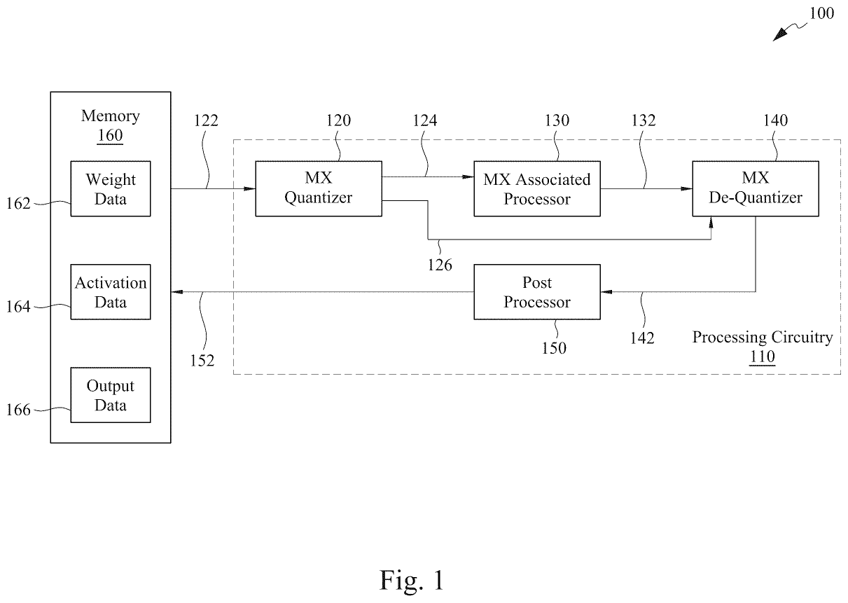

FIG. 1 is a block diagram of a processing device 100, in accordance with some embodiments. Processing device 100 in FIG. 1 is a simplified, non-limiting example of a part of a computing device. In some embodiments, processing device 100 corresponds to at least a portion of an artificial intelligence (AI) acceleration device. In some embodiments, an AI acceleration device includes one or a combination of one or more central processing units (CPUs), one or more graphic processing units (GPUs), one or more tensor processing units (TPUs), application-specific integrated circuits (ASICs), and/or other types of processing units or circuits.

As shown in FIG. 1, processing device 100 includes processing circuitry 110, which includes a micro-scaling quantizer (120, labeled “MX Quantizer”), a micro-scaling associated processor (130, labeled “MX Associated Processor”), a micro-scaling de-quantizer (140, labeled “MX De-Quantizer”), and a post processor 150. Processing device 100 further includes a memory 160, which includes memory cells configured as storage areas for storing at least weight data 162, activation data 164, and output data 166.

In some embodiments, micro-scaling quantizer 120 is configured to receive input data 122 from memory 160, where input data 122 includes weight data 162 and activation data 164. In some embodiments, weight data 162 includes a first set of digital representations of a first set of numbers that correspond to weight coefficients from one layer to a subsequent layer of a neural network, or filter coefficients of a convolutional neural network. In some embodiments, activation data 164 includes a second set of digital representations of a second set of numbers that correspond to node values of one layer of a neural network. In some embodiments, the first set of digital representations and the second set of digital representations are in a 16-bit floating point format (e.g., based on Institute of Electrical and Electronics Engineers (IEEE) half-precision floating-point format, or also known as FP16 format) or a 32-bit floating point format (e.g., based on IEEE single-precision floating-point format, or also known as FP32 format).

In some embodiments, micro-scaling quantizer 120 is configured to generate micro-scaling output data (including a first portion 124 and a second portion 126) based on a numerical data quantization process. In some embodiments, first portion 124 of the micro-scaling output data includes a first set of quantized digital representations of the first set of numbers and/or a second set of quantized digital representations of the second set of numbers. In some embodiments, second portion 126 of the micro-scaling output data includes a first biased exponent scaling factor associated with the first set of quantized digital representations of the first set of numbers and/or a second biased exponent scaling factor associated with the second set of quantized digital representations. In some embodiments, the combination of the first set of quantized digital representations and the associated first biased exponent scaling factor and/or the combination of the second set of quantized digital representations and the associated second biased exponent scaling factor are consistent with a micro-scaling data format, such as MXFP8, MXFP6, MXFP4, MXINT8, or MXINT4 data formats based on Open Compute Project (OCP) micro-scaling formats. In some embodiments, micro-scaling quantizer 120 is configured to send first portion 124 of the micro-scaling output data to micro-scaling associated processor 130 and to send second portion 126 of the micro-scaling output data to micro-scaling de-quantizer 140.

In some embodiments, micro-scaling associated processor 130 is configured to receive first portion 124 of the micro-scaling output and output numerical data 132 that is a result of processing the first set of quantized digital representations and the second set of quantized digital representations. In some embodiments and as a non-limiting example, micro-scaling associated processor 130 as illustrated in this disclosure is configured to determine a result based on a multiply-accumulate (MAC) operation of the first set of quantized digital representations and the second set of quantized digital representations. In some embodiments, micro-scaling associated processor 130 is configured to determine a result of processing first portion 124 of the micro-scaling output data based on one or more other operations in the technology fields of artificial intelligence (AI) computation, machine learning, language/text processing (e.g., for large language models (LLMs)), data encoding/decoding, audio processing, and/or graphic processing.

In some embodiments, because first portion 124 of the micro-scaling output data is in a data format that has a bit-length less than that of input data 122 (at the cost of precision due to quantization by micro-scaling quantizer 120), the size and complexity of micro-scaling associated processor 130 may be reduced in comparison with its counterpart that processes the input data 122 directly. In some embodiments, benefits and improvements of using the micro-scaling data format as discussed in this disclosure include enabling more scaled computation units, higher energy efficiency (e.g., measurable based on tera operations per watt, or TOPS/W) and higher area efficiency (e.g., measurable based on tera operations per square millimeter, or TOPS/mm²), while reducing memory bandwidth and capacity requirements.

In some embodiments, micro-scaling de-quantizer 140 is configured to receive numerical data 132 from micro-scaling associated processor 130 and output a de-quantized digital representation 142 of numerical data 132. In some embodiments, de-quantized digital representation 142 is in a 16-bit floating point format (e.g., FP16 format) or a 32-bit floating point format (e.g., FP32 format). In some embodiments, post processor 150 is configured to receive de-quantized digital representation 142 of numerical data 132 from micro-scaling de-quantizer 140, perform one or more post processing operations, and output post-processed data 152 to memory 160. In some embodiments, post-processed data 152 corresponds to at least a portion of output data 166 stored in memory 160. In some embodiments, the one or more post processing operations performed by post processor 150 include introducing non-linearity to de-quantized digital representation 142 of numerical data 132, pooling de-quantized digital representation 142 of numerical data 132, and/or other suitable operations.

In some embodiments, unless otherwise specified in this disclosure, each one of one or more components of processing circuitry 110 is implemented, in whole or in part, based on one or more processors executing a set of instructions or computer codes stored in memory 160 and/or another memory included in processing circuitry 110, based on a hardware circuit block configured to perform corresponding operations, or a combination of the above. In some embodiments, processing circuitry 110 includes one or more cells configured based on a compute-in-memory (CIM) architecture.

In many applications, standard data formats used for AI workloads are usually FP32 or FP16. Micro-scaling (MX) formats as introduced by OCP correspond to quantizing data in FP32 or FP16 format into a shorter bit-length (i.e., 8-bit or below) format such as MX floating point formats (MXFP8, MXFP6, or MXFP4) or MX integer formats (MXINT8 or MXINT4). In some non-limiting application examples (e.g., operations regarding deep neural network, vision transformer, and/or large language model), the accuracy degradation caused by implementing processing circuitry that processes data using MX formats instead of using FP32/FP16 formats is less than 3%, in exchange for various improvements such as more than 2 times tera operations per second (TOPS), more than 3.7 times TOPS/W, more than 5.2 times TOPS/mm², and/or less than 0.36 times of chip area.

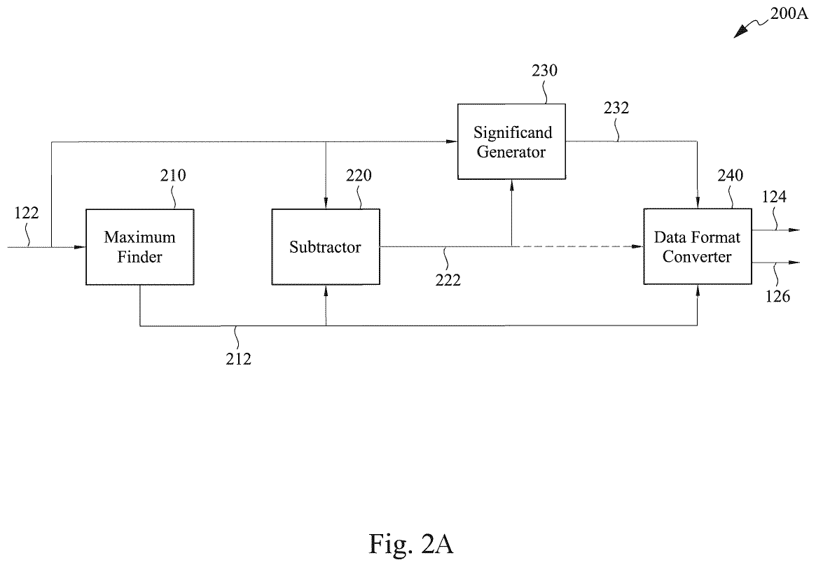

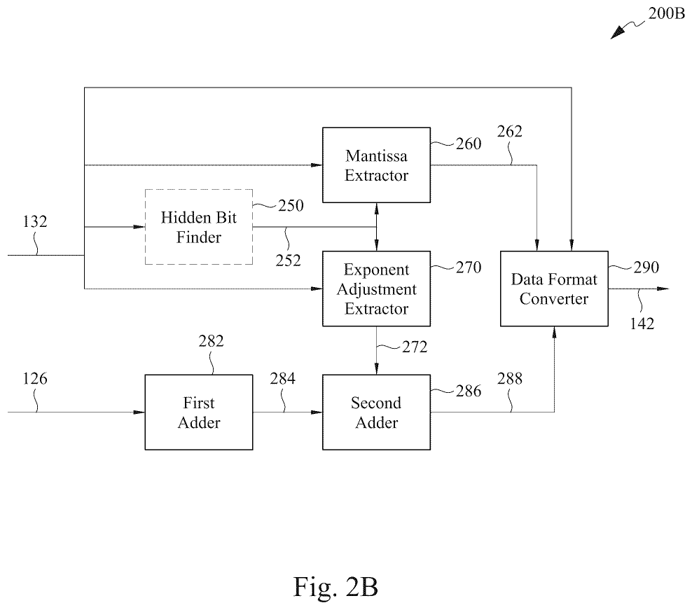

FIG. 2A is a block diagram of a micro-scaling quantizer 200A, in accordance with some embodiments. In some embodiments, micro-scaling quantizer 200A corresponds to micro-scaling quantizer 120 in FIG. 1. As shown in FIG. 2A, micro-scaling quantizer 200A is configured to receive input data 122 and output first portion 124 of the micro-scaling output data and second portion 126 of the micro-scaling output data as described in FIG. 1.

Micro-scaling quantizer 200A includes a maximum finder 210, a subtractor 220, a significand generator 230, and a data format converter 240. In some embodiments, input data 122 includes a set of digital representations of a set of numbers corresponding to weight data 162 and/or activation data 164 in FIG. 1. In some embodiments, maximum finder 210 is configured to determine a maximum exponent 212 from a set of exponents of the set of digital representations. In some embodiments, maximum finder 210 is configured to output maximum exponent 212 to subtractor 220, significand generator 230, and data format converter 240.

In some embodiments, subtractor 220 is configured to obtain a set of scaled exponents 222 based on subtraction of the maximum exponent 212 from each one of the set of exponents of the set of digital representations. In some embodiments, subtractor 220 is configured to output the set of scaled exponents 222 to significand generator 230. In some embodiments, subtractor 220 is also configured to output the set of scaled exponents 222 to data format converter 240.

In some embodiments, in a case that the micro-scaling output data is based on an MX integer format (e.g., MXINT8 or MXINT4), significand generator 230 is configured to obtain a set of quantized significands based on a set of mantissas of the set of digital representations of the set of numbers and the set of scaled exponents. In some embodiments, in a case that the micro-scaling output data is based on an MX floating point format (e.g., MXFP8, MXFP6, or MXFP4), significand generator 230 is configured to obtain a set of quantized mantissas based on the set of mantissas. In some embodiments, significand generator 230 is configured to output the set of quantized significands or the set of quantized mantissas (e.g., output data 232) to data format converter 240.

In some embodiments, in a case that the micro-scaling output data is based on an MX integer format (e.g., MXINT8 or MXINT4), data format converter 240 is configured to output, as first portion 124 of the micro-scaling output data, a set of quantized digital representations of the set of numbers based on the set of quantized significands (output data 232). In some embodiments, in a case that the micro-scaling output data is based on an MX floating point format (e.g., MXFP8, MXFP6, or MXFP4), data format converter 240 is configured to output, as first portion 124 of the micro-scaling output data, a set of quantized digital representations of the set of numbers based on the set of quantized mantissas (output data 232) and the set of scaled exponents 222. In some embodiments, data format converter 240 is configured to output, as second portion 126 of the micro-scaling output data, a biased exponent scaling factor associated with the set of quantized digital representations based on the maximum exponent 212. In some embodiments, a bit-length of the biased exponent scaling factor is 8 bits.

In some embodiments, in a case that the micro-scaling output data is based on an MX integer format (e.g., MXINT8 or MXINT4), significand generator 230 is configured to obtain a set of shifted significands based on the set of mantissas and the set of scaled exponents, and round the set of shifted significands to a target bit-length to become the set of quantized significands. In some embodiments, significand generator 230 is further configured to convert the set of mantissas to a set of significands based on restoration of a first non-zero significand digit to each one of the set of mantissas, and right-shift the set of significands by corresponding numbers of bits indicated by the set of scaled exponents to become the set of shifted significands. In some embodiments, the target bit-length is 7 bits (e.g., for output in MXINT8 format). In some embodiments, the set of quantized digital representations includes a set of two's complement integer values of the set of quantized significands based on a set of sign bits of the set of digital representations of the set of numbers. In some embodiments, a bit-length of each one of the set of two's complement integer values is 8 bits (e.g., for output in MXINT8 format).

In some embodiments, in a case that the micro-scaling output data is based on an MX floating point format (e.g., MXFP8, MXFP6, or MXFP4), significand generator 230 is configured to obtain an unbiased exponent scaling factor based on subtraction of a target offset from the maximum exponent, and obtain the set of scaled exponents based on subtraction of the unbiased exponent scaling factor from each one of the set of exponents, each exponent of the set of scaled exponents having a target exponent bit-length. In some embodiments, the target exponent bit-length ranges from 5 bits to 2 bits. In some embodiments, significand generator 230 is further configured to round the set of mantissas to a target mantissa bit-length to become the set of quantized mantissas. In some embodiments, the target mantissa bit-length ranges from 3 bits to 1 bit.

In some embodiments, in a case that the micro-scaling output data is based on an MX floating point format (e.g., MXFP8, MXFP6, or MXFP4), each one of the set of quantized digital representations includes a corresponding one of a set of sign bits of the set of digital representations of the set of numbers, a corresponding one of the set of scaled exponents, and a corresponding one of the set of quantized mantissas. In some embodiments, a bit-length of each one of the set of quantized digital representations is 8 bits (e.g., MXFP8), a bit-length of each one of the set of scaled exponents is 4 bits (e.g., 4-bit exponent), and a bit-length of each one of the set of quantized mantissas is 3 bits (3-bit mantissa) (also known as MXFP8(E4M3) format). In some embodiments, the bit-length of each one of the set of quantized digital representations is 8 bits (e.g., MXFP8), the bit-length of each one of the set of scaled exponents is 5 bits (e.g., 5-bit exponent), and the bit-length of each one of the set of quantized mantissas is 2 bits (2-bit mantissa) (also known as MXFP8(E5M2) format). In some embodiments, the bit-length of each one of the set of quantized digital representations is 6 bits (e.g., MXFP6), the bit-length of each one of the set of scaled exponents is 2 bits (e.g., 2-bit exponent), and the bit-length of each one of the set of quantized mantissas is 3 bits (3-bit mantissa) (also known as MXFP6(E2M3) format). In some embodiments, the bit-length of each one of the set of quantized digital representations is 6 bits (e.g., MXFP6), the bit-length of each one of the set of scaled exponents is 3 bits (e.g., 3-bit exponent), and the bit-length of each one of the set of quantized mantissas is 2 bits (2-bit mantissa) (also known as MXFP6(E3M2) format). In some embodiments, the bit-length of each one of the set of quantized digital representations is 4 bits (e.g., MXFP4), the bit-length of each one of the set of scaled exponents is 2 bits (e.g., 2-bit exponent), and the bit-length of each one of the set of quantized mantissas is 1 bit (1-bit mantissa) (also known as MXFP4(E2M1) format).

In some embodiments, a numerical data quantization process based on the example of FIG. 2A avoids performing the logarithm and/or exponential calculations, replaces multiplication operations in a linear space to shifting and/or addition operations in an exponential space, and replaces division operations in a linear space to subtraction operations in an exponential space. Accordingly, the computational complexity and conversion speed is improved.

FIG. 2B is a block diagram of a micro-scaling de-quantizer 200B, in accordance with some embodiments. In some embodiments, micro-scaling de-quantizer 200B corresponds to micro-scaling de-quantizer 140 in FIG. 1. As shown in FIG. 2B, micro-scaling de-quantizer 200B is configured to receive numerical data 132 and second portion 126 of the micro-scaling output data, and output de-quantized digital representation 142 of numerical data 132 as described in FIG. 1.

Micro-scaling de-quantizer 200B includes a hidden bit finder 250, a mantissa extractor 260, an exponent adjustment extractor 270, a first adder 282, a second adder 286, and a data format converter 290. In some embodiments, numerical data 132 includes a numerical data that is a result of processing a first set of quantized digital representations of a first set of numbers (e.g., corresponding to weight data 162 in FIG. 1) and a second set of quantized digital representations of a second set of numbers (e.g., corresponding to activation data 164 in FIG. 1). In some embodiments, hidden bit finder 250 is configured to identify a first non-zero significand digit of the numerical data and provide such information 252 to mantissa extractor 260 and exponent adjustment extractor 270. In some embodiments, hidden bit finder 250 is incorporated in mantissa extractor 260 and/or exponent adjustment extractor 270. In some embodiments, the functionality of hidden bit finder 250 is embedded in mantissa extractor 260 and/or exponent adjustment extractor 270, and hidden bit finder 250 is thus omitted. In some embodiments, the functionality of hidden bit finder 250 is not needed for the subsequent processing by mantissa extractor 260 and exponent adjustment extractor 270, and hidden bit finder 250 is thus omitted.

In some embodiments, mantissa extractor 260 is configured to extract a mantissa 262 of the de-quantized digital representation of the numerical data 132 and output the mantissa 262 to data format converter 290. In some embodiments, mantissa extractor 260 is configured to extract the mantissa further based on removal of the first non-zero significand digit from the numerical data (e.g., based on the information 252 from hidden bit finder 250). In some embodiments, exponent adjustment extractor 270 is configured to extract an exponent adjustment 272 from the numerical data 132 and output the exponent adjustment 272 to second adder 286. In some embodiments, exponent adjustment extractor 270 is configured to extract the exponent adjustment 272 further based on a digit position of the first non-zero significand digit within the numerical data (e.g., based on the information 252 from hidden bit finder 250).

In some embodiments, first adder 282 is configured to obtain a combined exponent scaling factor 284 based on a first exponent scaling factor associated with the first set of quantized digital representations and a second exponent scaling factor associated with the second set of quantized digital representations (e.g., included in second portion 126 of the micro-scaling output data). In some embodiments, second adder 286 is configured to obtain an unbiased exponent 288 of the numerical data based on the combined exponent scaling factor 284 from first adder 282 and the exponent adjustment 272 from exponent adjustment extractor 270.

In some embodiments, data format converter 290 is configured to output de-quantized digital representation 142 of the numerical data. In some embodiments, the digital representation includes the mantissa 262 of the digital representation and an exponent of the digital representation based on the unbiased exponent 288 of the numerical data.

In some embodiments, in a case that the first set of quantized digital representations and the second set of quantized digital representations are based on an MX integer format (e.g., MXINT8 or MXINT4), second adder 286 is configured to obtain the unbiased exponent 288 based on addition of the combined exponent scaling factor 284 and the exponent adjustment 272. In some embodiments, in a case that the first set of quantized digital representations and the second set of quantized digital representations are based on an MX floating point format (e.g., MXFP8, MXFP6, or MXFP4), second adder 286 is configured to obtain the unbiased exponent 288 based on addition of a maximum product exponent of the first set of quantized digital representations and the second set of quantized digital representations, the combined exponent scaling factor 284, and the exponent adjustment 272. In some embodiments, the maximum product exponent is an unbiased exponent value, and the combined exponent scaling factor is another unbiased exponent value.

In some embodiments, the de-quantized digital representation of the numerical data is based on FP16 and includes a sign bit extracted from the numerical data 132, the exponent having a bit-length of 5 bits, and the mantissa having a bit-length of 10 bits. In some embodiments, the de-quantized digital representation of the numerical data is based on FP32 and includes a sign bit extracted from the numerical data 132, the exponent having a bit-length of 8 bits, and the mantissa having a bit-length of 23 bits.

In some embodiments, a numerical data de-quantization process based on the example of FIG. 2B also avoids performing the logarithm and/or exponential calculations, and provides a convenient approach to convert numerical data from an exponential space back to a linear space. Accordingly, with the benefits of using a micro-scaling format as discussed in FIG. 2A, the results can still be obtained in the linear space without increasing the computational complexity and conversion costs.

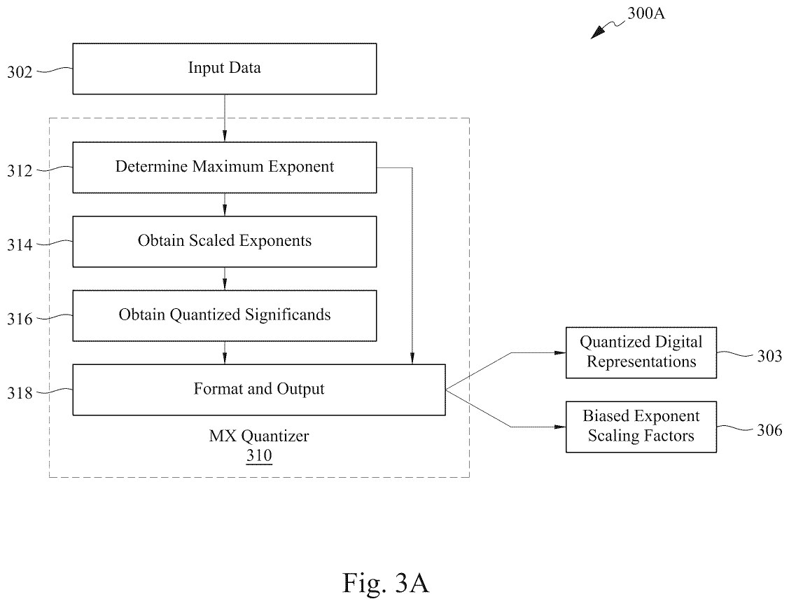

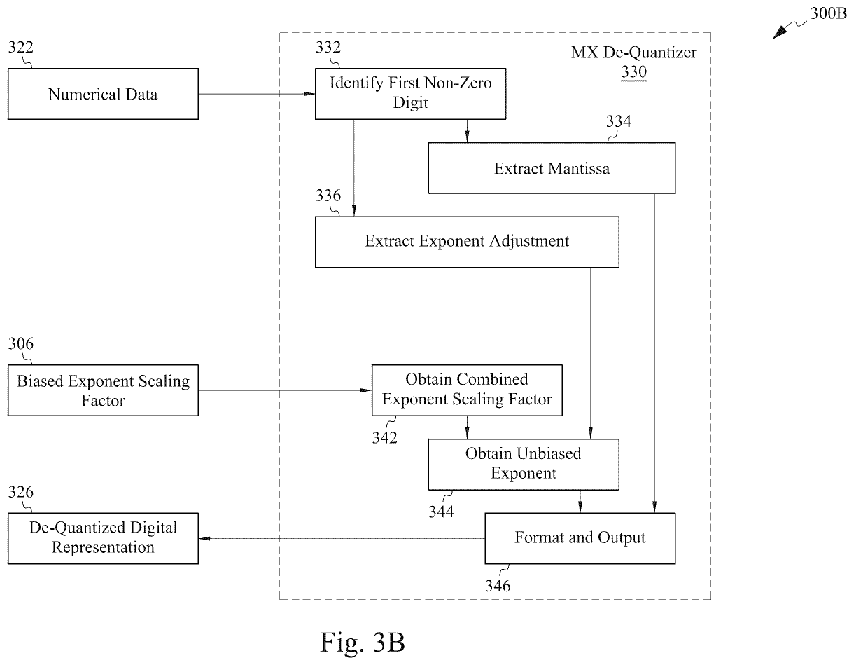

FIG. 3A is a process flow diagram 300A of a numerical data quantization process flow example, in accordance with some embodiments. Process flow diagram 300A includes various stages that correspond to operations performed by a micro-scaling quantizer 310, which corresponds to micro-scaling quantizer 120 in FIG. 1 and/or micro-scaling quantizer 200A in FIG. 2A. In some embodiments, the numerical data quantization example receives two sets of digital representations of two sets of numbers as input data 302, and outputs two sets of quantized digital representations 304 and two associated biased exponent scaling factors 306. In some embodiments, each set of quantized digital representations includes 8, 16, 32, or 64 entries.

In this non-limiting example, for illustration purposes, each set of quantized digital representations includes 4 entries. In this non-limiting example, the input data 302 is based on a FP16 format, and the quantized digital representations 304 and associated biased exponent scaling factors 306 are based on an MXINT8 format. For example, input data 302 includes a set of weights and asset of activation inputs as follows.

| Weights (FP16) | Activation Inputs (FP16) |
|---|---|
| 0011 1011 1111 1000 | 1011 0111 0101 0001 |
| 0011 0000 0101 1001 | 0011 1010 0101 1110 |
| 1100 0000 1010 0001 | 0011 1010 1000 0111 |
| 0010 1000 1011 1001 | 1010 1011 0000 1010 |

In some embodiments, each one of the digital representations includes a sign bit at the left-most bit thereof, followed by 5 bits of exponent, and then 10 bits of mantissa.

At stage 312, a maximum exponent of each set of digital representations included in the input data are determined, e.g., by maximum finder 210 in FIG. 2A. In this example, the maximum exponent of the weights is “10000,” and the maximum exponent of the activation inputs is “01110.” In some embodiments, the maximum exponents at this stage are biased exponents, based on a bias of 15. Accordingly, the unbiased exponent of the weights is indeed “1,” and the unbiased exponent of the activation inputs is indeed “−1.”

At stage 314, a set of scaled exponents of the weights and a set of scaled exponents of the activation inputs are obtained, e.g., by subtractor 220 in FIG. 2A. In some embodiments, a scaled exponent is calculated based on subtraction of the maximum exponent from a corresponding exponent. For example, the sets of scaled exponents are as follows.

| Scaled Exponents of | Scaled Exponents of |
|---|---|
| Weights | Activation Inputs |
| 2 | 1 |
| 4 | 1 |
| 0 | 0 |
| 6 | 4 |

At stage 316, corresponding sets of quantized significands are obtained, e.g., by significand generator 230 in FIG. 2A. In some embodiments, a quantized significand is obtained by converting a corresponding mantissa into a significand by adding a hidden bit, right shifting the significand by a number of bits based on the corresponding scaled exponent, and rounding the shifted significand to a target bit-length. In this non-limiting example, the target bit-length is 7. For example, the shifted significands are as follows.

| Shifted | Shifted |
|---|---|
| Significands of | Significands of |
| Weights | Activation Inputs |
| 001 11 1111 1000 | 01 11 0101 0001 |
| 00001 00 0101 1001 | 01 10 0101 1110 |
| 1 00 1010 0001 | 1 10 1000 0111 |
| 0000001 00 1011 1001 | 00001 11 0000 1010 |

Also, the quantized significands after rounding are as follows.

| Quantized | Quantized |
|---|---|
| Significands of | Significands of |
| Weights | Activation Inputs |
| 0100000 | 0111011 |
| 0000100 | 0100110 |
| 1001010 | 1101000 |
| 0000001 | 0000111 |

At stage 318, the sets of maximum exponents and the sets of quantized significands are collected and arranged consistent with an output format, e.g., MXINT8 in this example. In some embodiments, the quantized significands are converted into 8-bit two's complement (labeled as “2's Com” in the table below) integer values to become the corresponding quantized digital representations 304. For example, the quantized digital representations are as follows.

| | Quantized Digital |
|---|---|
| Quantized Digital | Representations |
| Representations | of Activation |
| of Weights (2's Com) | Inputs (2's Com) |
| 0010 0000 | 1100 0101 |
| 0000 0100 | 0010 0110 |
| 1011 0110 | 0110 1000 |
| 0000 0001 | 1111 1001 |

In some embodiments, the maximum exponent of the weights and the maximum exponent of the activation inputs are converted into 8-bit biased exponent scaling factors with a bias of 127. For example, the biased exponent scaling factor associated with the set of quantized digital representations of weights is “1000 0000,” and the biased exponent scaling factor associated with the set of quantized digital representations of activation inputs is “0111 1110.”

FIG. 3B is a process flow diagram 300B of a numerical data de-quantization process flow example, in accordance with some embodiments. Process flow diagram 300B includes various stages that correspond to operations performed by a micro-scaling de-quantizer 330, which corresponds to micro-scaling de-quantizer 140 in FIG. 1 and/or micro-scaling de-quantizer 200B in FIG. 2B. In some embodiments, the numerical data de-quantization example receives numerical data 322 that is a result of processing a first set of quantized digital representations of a first set of numbers (e.g., the quantized digital representations of weights from FIG. 3A) and a second set of quantized digital representations of a second set of numbers (e.g., the quantized digital representations of activation inputs from FIG. 3A). In some embodiments, the numerical data de-quantization example also receives the biased exponent scaling factors 306 associated with the first set of quantized digital representations and the second set of quantized digital representations. In some embodiments, the numerical data de-quantization example outputs a de-quantized digital representation 326 of numerical data 322.

In this non-limiting example, for illustration purposes, numerical data 322 corresponds to a result of processing the quantized digital representations from FIG. 3A. For example, numerical data 322 is a two's complement value of “111101.101100100001.” In this example, the two left-most bits are sign bits, and the unsigned binary value of the numerical data 322 is “0010.010011011111.” At stage 332, a first non-zero significand digit of the numerical data (in the form of unsigned binary value) is identified, e.g., by hidden bit finder 250 in FIG. 2B. In this example, the first non-zero significand digit is the second digit to the left of the dot separator (i.e., the “21” digit).

At stage 334, based on the information from stage 332, the mantissa of the de-quantized digital representation 326 is extracted based on the unsigned binary value of the numerical data 322, e.g., by mantissa extractor 260 in FIG. 2B. In some embodiments, the mantissa is also rounded to a bit-length of 10 bits based on the de-quantized digital representation 326 is in a FP16 format in this non-limiting example. In this non-limiting example, the extracted mantissa is “0010011100” (rounded). Also, at stage 336, based on the information from stage 332, an exponent adjustment is extracted from the numerical data 322, e.g., by exponent adjustment extractor 270 in FIG. 2B. In this non-limiting example, the exponent adjustment is “1” as the extracted mantissa starts at the first digit to the left of the dot separator.

At stage 342, based on the biased exponent scaling factors 306, a combined exponent scaling factor is obtained, e.g., by first adder 282 in FIG. 2B. In some embodiments, the combined exponent scaling factor is obtained based on adding an unbiased counterpart of the exponent scaling factor associated with the set of quantized digital representations of weights and an unbiased counterpart of the exponent scaling factor associated with the set of quantized digital representations of activation inputs. In this non-limiting example, the combined exponent scaling factor is 0.

At stage 344, an unbiased exponent of the numerical data 322 is obtained based on the exponent adjustment from stage 336 and the combined exponent scaling factor from stage 342, e.g., by second adder 286 in FIG. 2B. In some embodiments, the unbiased exponent is obtained based on adding the exponent adjustment and the combined exponent scaling factor. In this non-limiting example, the unbiased exponent is 1.

At stage 346, the de-quantized digital representation 326 of numerical data 322 is obtained, e.g., by data format converter 290 in FIG. 2B. In some embodiments, the de-quantized digital representation 326 is based on FP16. In some embodiments, the de-quantized digital representation 326 includes a sign bit from the numerical data 322, the mantissa from stage 334, and a biased exponent based on the unbiased exponent from stage 344. In this non-limiting example, the de-quantized digital representation 326 of the numerical data 322 in FP16 format is “1100 0000 1001 1100.”

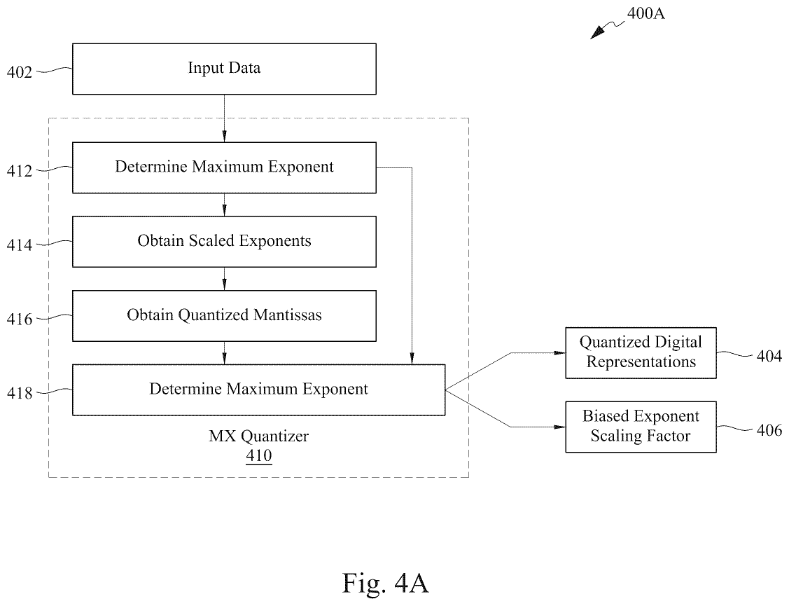

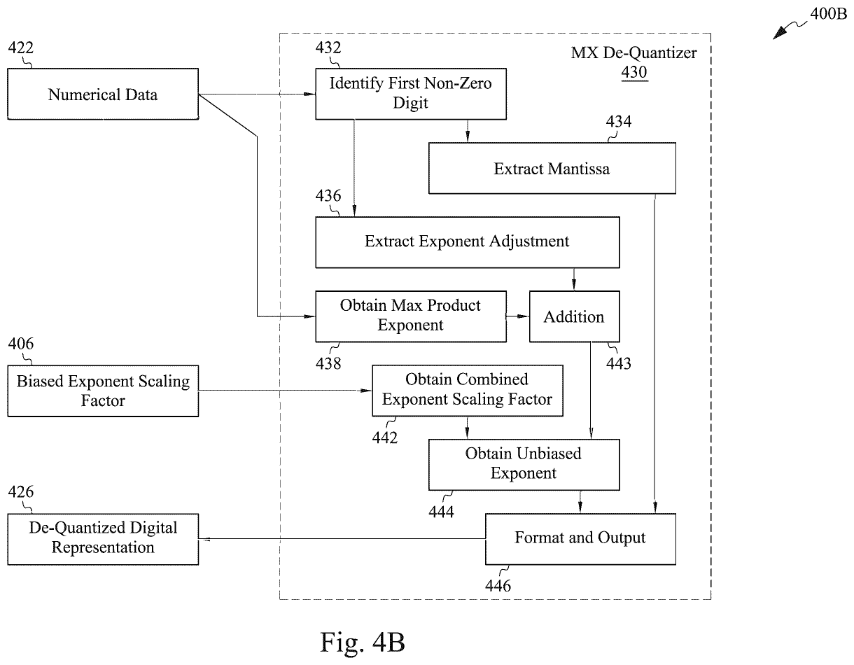

FIG. 4A is a process flow diagram 400A of another numerical data quantization process flow example, in accordance with some embodiments. Process flow diagram 400A includes various stages that correspond to operations performed by a micro-scaling quantizer 410, which corresponds to micro-scaling quantizer 120 in FIG. 1 and/or micro-scaling quantizer 200A in FIG. 2A. In some embodiments, the numerical data quantization example receives two sets of digital representations of two sets of numbers as input data 402, and outputs two sets of quantized digital representations 304 and two associated biased exponent scaling factors 406. In some embodiments, each set of quantized digital representations includes 8, 16, 32, or 64 entries.

In this non-limiting example, for illustration purposes, each set of quantized digital representations includes 4 entries. In this non-limiting example, the input data 402 is based on a FP16 format, and the quantized digital representations 404 and associated biased exponent scaling factors 306 are based on an MXFP8(E4M3) format. In this non-limiting example, input data 402 includes a set of weights and asset of activation inputs the same as the example in FIG. 3A.

At stage 412, a maximum exponent of each set of digital representations included in the input data are determined, e.g., by maximum finder 210 in FIG. 2A. In this example, the maximum exponent of the weights is “10000,” and the maximum exponent of the activation inputs is “01110.” In some embodiments, the maximum exponents at this stage are biased exponents, based on a bias of 15. Accordingly, the unbiased exponent of the weights is indeed “1,” and the unbiased exponent of the activation inputs is indeed “−1.” Moreover, to match the MXFP8(E4M3) format, the unbiased exponents are further scaled by subtracting a target offset (e.g., 8 for MXFP8(E4M3)) therefrom. As such, the scaled exponents become an unbiased exponent scaling factor of the weights that is “−7,” and an unbiased exponent scaling factor of the activation inputs that is “−9.”

At stage 414, a set of scaled exponents of the weights and a set of scaled exponents of the activation inputs are obtained, e.g., by subtractor 220 in FIG. 2A. In some embodiments, a scaled exponent is calculated based on subtraction of a corresponding unbiased exponent scaling factor from a corresponding unbiased exponent. For example, the sets of scaled exponents are as follows.

| Scaled Exponents of | Scaled Exponents of |
|---|---|
| Weights | Activation Inputs |
| 6 | 7 |
| 4 | 7 |
| 8 | 8 |
| 2 | 4 |

The sets of scaled exponents are converted into 4-bit binary values as follows

| Scaled Exponents of | Scaled Exponents of |
|---|---|
| Weights | Activation Inputs |
| 1101 | 1110 |
| 1011 | 1110 |
| 1111 | 1111 |
| 1001 | 1011 |

At stage 416, corresponding sets of quantized mantissas are obtained, e.g., by significand generator 230 in FIG. 2A. In some embodiments, a quantized mantissa is obtained by rounding a corresponding mantissa to a target bit-length. In this non-limiting example, the target bit-length is 3. For example, the quantized mantissa are as follows.

| Quantized Mantissas of | Quantized Mantissas of |
|---|---|
| Weights | Activation Inputs |
| 111 | 111 |
| 001 | 001 |
| 001 | 101 |
| 001 | 110 |

At stage 418, the sets of scaled exponents and the sets of quantized mantissas, together with the sign bits included in the input data 402, are collected and arranged consistent with an output format, e.g., MXFP8(E4M3) in this example. For example, the quantized digital representations are as follows.

| Quantized Digital | Quantized Digital |
|---|---|
| Representations | Representations |
| of Weights | of Activation Inputs |
| 0110 1111 | 1111 0111 |
| 0101 1001 | 0111 0001 |
| 1111 1001 | 0111 1101 |
| 0100 1001 | 1101 1110 |

In some embodiments, the unbiased exponent scaling factor of the weights and unbiased exponent scaling factor of the activation inputs are converted into 8-bit biased exponent scaling factors with a bias of 127. For example, the biased exponent scaling factor associated with the set of quantized digital representations of weights is “0111 1000,” and the biased exponent scaling factor associated with the set of quantized digital representations of activation inputs is “0111 0110.”

FIG. 4B is a process flow diagram 400B of another numerical data de-quantization process flow example, in accordance with some embodiments. Process flow diagram 400B includes various stages that correspond to operations performed by a micro-scaling de-quantizer 430, which corresponds to micro-scaling de-quantizer 140 in FIG. 1 and/or micro-scaling de-quantizer 200B in FIG. 2B. In some embodiments, the numerical data de-quantization example receives numerical data 422 that is a result of processing a first set of quantized digital representations of a first set of numbers (e.g., the quantized digital representations of weights from FIG. 4A) and a second set of quantized digital representations of a second set of numbers (e.g., the quantized digital representations of activation inputs from FIG. 4A). In some embodiments, the numerical data de-quantization example also receives the biased exponent scaling factors 406 associated with the first set of quantized digital representations and the second set of quantized digital representations. In some embodiments, the numerical data de-quantization example outputs a de-quantized digital representation 426 of numerical data 422.

In this non-limiting example, for illustration purposes, numerical data 422 corresponds to a result of processing the quantized digital representations from FIG. 4A. For example, numerical data 422 is a two's complement value of “111101.1100010100100010.” In this example, the two left-most bits are sign bits, and the unsigned binary value of the numerical data 422 is “0010.0011101011011110.” At stage 432, a first non-zero significand digit of the numerical data (in the form of unsigned binary value) is identified, e.g., by hidden bit finder 250 in FIG. 2B. In this example, the first non-zero significand digit is the second digit to the left of the dot separator (i.e., the “21” digit).

At stage 434, based on the information from stage 432, the mantissa of the de-quantized digital representation 426 is extracted based on the unsigned binary value of the numerical data 422, e.g., by mantissa extractor 260 in FIG. 2B. In some embodiments, the mantissa is also rounded to a bit-length of 10 bits based on the de-quantized digital representation 426 is in a FP16 format in this non-limiting example. In this non-limiting example, the extracted mantissa is “0001110110” (rounded). Also, at stage 436, based on the information from stage 432, an exponent adjustment is extracted from the numerical data 422, e.g., by exponent adjustment extractor 270 in FIG. 2B. In this non-limiting example, the exponent adjustment is “1” as the extracted mantissa starts at the first digit to the left of the dot separator.

At stage 442, based on the biased exponent scaling factors 406, a combined exponent scaling factor is obtained, e.g., by first adder 282 in FIG. 2B. In some embodiments, the combined exponent scaling factor is obtained based on adding an unbiased counterpart of the exponent scaling factor associated with the set of quantized digital representations of weights and an unbiased counterpart of the exponent scaling factor associated with the set of quantized digital representations of activation inputs. In this non-limiting example, the combined exponent scaling factor is −16.

At stage 443, a modified exponent adjustment is obtained based on adding, e.g., by second adder 286 in FIG. 2B, the exponent adjustment from stage 436 and a maximum product exponent of the first set of quantized digital representations and the second set of quantized digital representations from numerical data 422. In this non-limiting example, the modified exponent adjustment is 17.

At stage 444, an unbiased exponent of the numerical data 422 is obtained based on the modified exponent adjustment from stage 443 and the combined exponent scaling factor from stage 442, e.g., by second adder 286 in FIG. 2B. In some embodiments, the unbiased exponent is obtained based on adding the modified exponent adjustment and the combined exponent scaling factor. In this non-limiting example, the unbiased exponent is 1.

At stage 446, the de-quantized digital representation 426 of numerical data 422 is obtained, e.g., by data format converter 290 in FIG. 2B. In some embodiments, the de-quantized digital representation 426 is based on FP16. In some embodiments, the de-quantized digital representation 426 includes a sign bit from the numerical data 422, the mantissa from stage 434, and a biased exponent based on the unbiased exponent from stage 444. In this non-limiting example, the de-quantized digital representation 426 of the numerical data 422 in FP16 format is “1100 0000 0111 0110.”

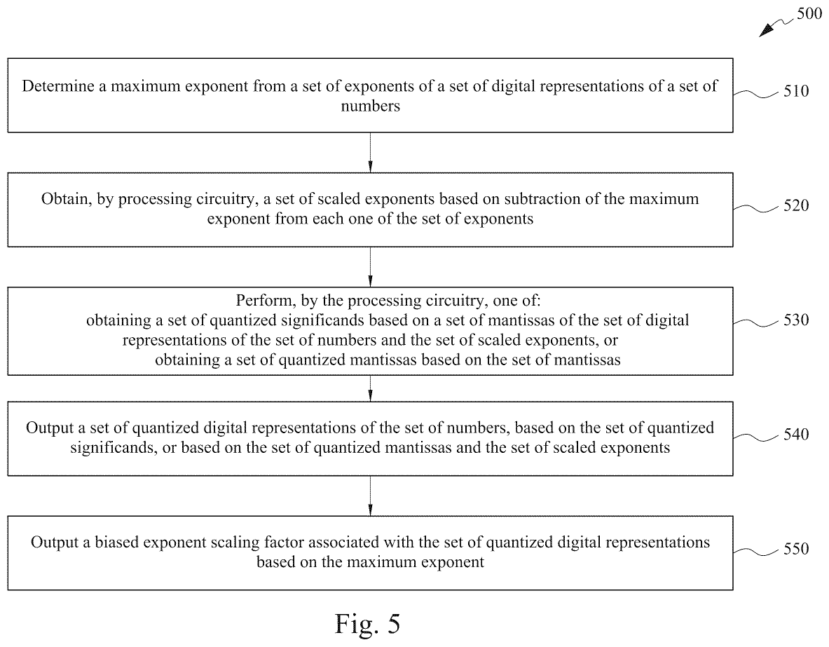

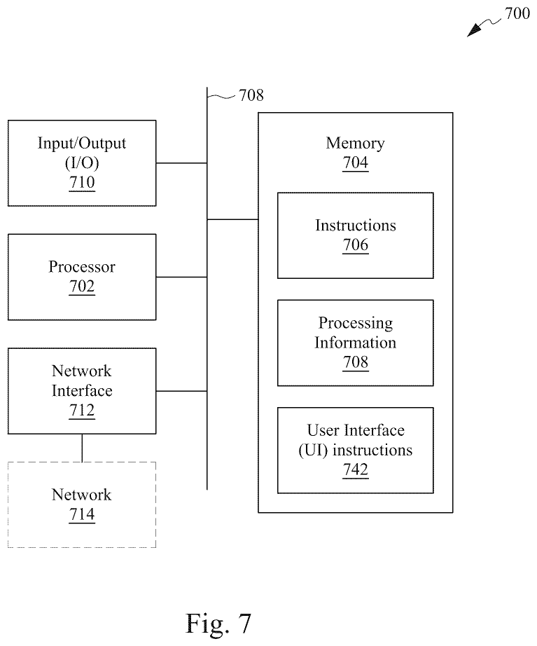

FIG. 5 is a flowchart of a method 500 of numerical data quantization, in accordance with some embodiments. In some embodiments, various operations of method 500 are performed by micro-scaling quantizer 120 in FIG. 1 or micro-scaling quantizer 200A in FIG. 2A. In some embodiments, method 500 corresponds to a process flow example in FIG. 3A or a process flow example in FIG. 4A. In some embodiments, method 500 corresponds to one or more operations performed based on, in whole or in part, a computing device 700 as illustrated in FIG. 7. As in FIG. 5, method 500 includes blocks 510-550.

At block 510, a maximum exponent is determined from a set of exponents of a set of digital representations of a set of numbers. In some embodiments, the set of digital representations of the set of numbers corresponds to at least a portion of input data 122 in FIGS. 1 and 2A, input data 302 in FIG. 3A, or input data in FIG. 4A. In some embodiments, the set of digital representations of the set of numbers corresponds to weight data 162 in FIG. 1 in FP16 format or FP32 format. In some embodiments, the set of digital representations of the set of numbers corresponds to activation data 164 in FIG. 1 in FP16 format or FP32 format. In some embodiments, block 510 corresponds to operations performed by maximum finder 210 in FIG. 2A. In some embodiments, block 510 corresponds to the operations at stage 312 in FIG. 3A or stage 412 in FIG. 4A.

At block 520, a set of scaled exponents is obtained, by processing circuitry (e.g., of micro-scaling quantizer 120, micro-scaling quantizer 200A, or computing device 700), based on subtraction of the maximum exponent from each one of the set of exponents. In some embodiments, block 520 corresponds to operations performed by subtractor 220 in FIG. 2A. In some embodiments, block 520 corresponds to the operations at stage 314 in FIG. 3A or stage 414 in FIG. 4A.

In some embodiments corresponding to outputting micro-scaling output data based on an MX floating point format (e.g., MXFP8, MXFP6, or MXFP4), the set of scaled exponents is obtained based on obtaining an unbiased exponent scaling factor based on subtraction of a target offset from the maximum exponent, and obtaining the set of scaled exponents based on subtraction of the unbiased exponent scaling factor from each one of the set of exponents, each exponent of the set of scaled exponents having a target exponent bit-length. In some embodiments, the target exponent bit-length ranges from 5 bits to 2 bits.

At block 530, in some embodiments corresponding to outputting micro-scaling output data based on an MX integer format (e.g., MXINT8 or MXINT4), the processing circuitry obtains a set of quantized significands based on a set of mantissas of the set of digital representations of the set of numbers and the set of scaled exponents. In some embodiments, the set of quantized digital representations includes a set of two's complement integer values of the set of quantized significands based on a set of sign bits of the set of digital representations of the set of numbers. In some embodiments, a bit-length of each one of the set of two's complement integer values is 8 bits. In some embodiments, block 530 corresponds to operations performed by significand generator 230 in FIG. 2A. In some embodiments, block 530 corresponds to the operations at stage 316 in FIG. 3A.

In some embodiments, the set of quantized significands is obtained based on obtaining a set of shifted significands based on the set of mantissas and the set of scaled exponents, and rounding the set of shifted significands to a target bit-length to become the set of quantized significands. In some embodiments, the set of quantized significands is obtained further based on converting the set of mantissas to a set of significands based on restoration of a first non-zero significand digit to each one of the set of mantissas, and right-shifting the set of significands by corresponding numbers of bits indicated by the set of scaled exponents to become the set of shifted significands. In some embodiments, the target bit-length is 7 bits.

At block 530, in some embodiments corresponding to outputting micro-scaling output data based on an MX floating point format (e.g., MXFP8, MXFP6, or MXFP4), the processing circuitry obtains a set of quantized mantissas based on the set of mantissas. In some embodiments, block 530 corresponds to operations performed by significand generator 230 in FIG. 2A. In some embodiments, block 530 corresponds to the operations at stage 416 in FIG. 4A.

In some embodiments, the set of quantized mantissas is obtained based on rounding the set of mantissas to a target mantissa bit-length to become the set of quantized mantissas. In some embodiments, the target mantissa bit-length ranges from 3 bits to 1 bit.

At block 540, in some embodiments corresponding to outputting micro-scaling output data based on an MX integer format (e.g., MXINT8 or MXINT4), a set of quantized digital representations of the set of numbers is output to a memory (e.g., memory 160) based on the set of quantized significands. In some embodiments, block 540 corresponds to operations performed by data format converter 240 in FIG. 2A. In some embodiments, block 540 corresponds to the operations at stage 318 in FIG. 3A.

At block 540, in some embodiments corresponding to outputting micro-scaling output data based on an MX floating point format (e.g., MXFP8, MXFP6, or MXFP4), a set of quantized digital representations of the set of numbers is output to a memory (e.g., memory 160) based on the set of quantized mantissas and the set of scaled exponents. In some embodiments, each one of the set of quantized digital representations includes a corresponding one of a set of sign bits of the set of digital representations of the set of numbers, a corresponding one of the set of scaled exponents, and a corresponding one of the set of quantized mantissas. In some embodiments, block 540 corresponds to operations performed by data format converter 240 in FIG. 2A. In some embodiments, block 540 corresponds to the operations at stage 418 in FIG. 4A.

In some embodiments based on a MXFP8(E4M3) format, a bit-length of each one of the set of quantized digital representations is 8 bits, a bit-length of each one of the set of scaled exponents is 4 bits, and a bit-length of each one of the set of quantized mantissas is 3 bits. In some embodiments based on a MXFP8(E5M2) format, the bit-length of each one of the set of quantized digital representations is 8 bits, the bit-length of each one of the set of scaled exponents is 5 bits, and the bit-length of each one of the set of quantized mantissas is 2 bits. In some embodiments based on a MXFP6(E2M3) format, the bit-length of each one of the set of quantized digital representations is 6 bits, the bit-length of each one of the set of scaled exponents is 2 bits, and the bit-length of each one of the set of quantized mantissas is 3 bits. In some embodiments based on a MXFP6(E3M2) format, the bit-length of each one of the set of quantized digital representations is 6 bits, the bit-length of each one of the set of scaled exponents is 3 bits, and the bit-length of each one of the set of quantized mantissas is 2 bits. In some embodiments based on a MXFP4(E2M1) format, the bit-length of each one of the set of quantized digital representations is 4 bits, the bit-length of each one of the set of scaled exponents is 2 bits, and the bit-length of each one of the set of quantized mantissas is 1 bits.

At block 550, a biased exponent scaling factor associated with the set of quantized digital representations is output to a memory (e.g., memory 160) based on the maximum exponent. In some embodiments, a bit-length of the biased exponent scaling factor is 8 bits. In some embodiments, block 550 corresponds to operations performed by data format converter 240 in FIG. 2A. In some embodiments, block 540 corresponds to the operations at stage 318 in FIG. 3A or at stage 418 in FIG. 4A.

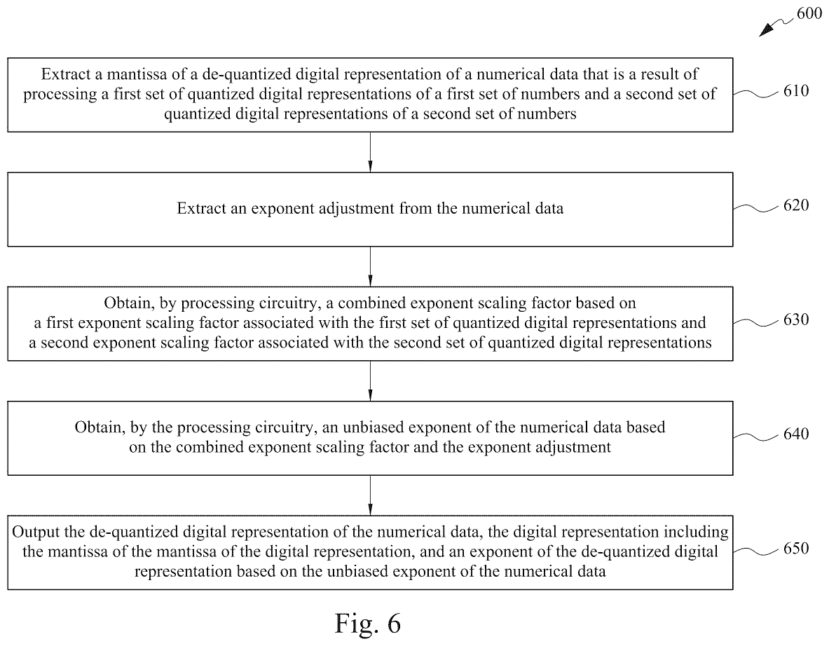

FIG. 6 is a flowchart of a method 600 of numerical data de-quantization, in accordance with some embodiments. In some embodiments, various operations of method 600 are performed by micro-scaling de-quantizer 140 in FIG. 1 or micro-scaling de-quantizer 200B in FIG. 2B. In some embodiments, method 600 corresponds to a process flow example in FIG. 3B or a process flow example in FIG. 4B. In some embodiments, method 600 corresponds to one or more operations performed based on, in whole or in part, a computing device 700 as illustrated in FIG. 7. As in FIG. 6, method 600 includes blocks 610-650.

At block 610, a mantissa of a de-quantized digital representation of a numerical data is extracted. In some embodiments, the numerical data is a result of processing a first set of quantized digital representations of a first set of numbers and a second set of quantized digital representations of a second set of numbers. In some embodiments, the first set of numbers and the second set of numbers are based on an MX integer format (e.g., MXINT8 or MXINT4) or an MX floating point format (e.g., MXFP8, MXFP6, or MXFP4). In some embodiments, the final de-quantized digital representation of the numerical data is in FP16 format or FP32 format. In some embodiments, block 610 corresponds to operations performed by mantissa extractor 260 in FIG. 2B. In some embodiments, block 610 corresponds to the operations at stage 334 in FIG. 3B or stage 434 in FIG. 4B.

At block 620, an exponent adjustment from the numerical data is extracted. In some embodiments, block 620 corresponds to operations performed by exponent adjustment extractor 270 in FIG. 2B. In some embodiments, block 620 corresponds to the operations at stage 336 in FIG. 3B or stage 436 in FIG. 4B.

In some embodiments, method 600 further includes identifying a first non-zero significand digit of the numerical data (e.g., corresponding to operations performed by hidden bit finder 250 in FIG. 2B, and the operations at stage 332 in FIG. 3B or stage 432 in FIG. 4B). In some embodiments, the mantissa is extracted further based on removal of the first non-zero significand digit from the numerical data. In some embodiments, the exponent adjustment is extracted further based on a digit position of the first non-zero significand digit within the numerical data.

At block 630, a combined exponent scaling factor is obtained, by processing circuitry (e.g., of micro-scaling de-quantizer 140, micro-scaling de-quantizer 200B, or computing device 700), based on a first exponent scaling factor associated with the first set of quantized digital representations and a second exponent scaling factor associated with the second set of quantized digital representations. In some embodiments, block 630 corresponds to operations performed by first adder 282 in FIG. 2B. In some embodiments, block 630 corresponds to the operations at stage 342 in FIG. 3B or stage 442 in FIG. 4B.

At block 640, an unbiased exponent of the numerical data is obtained, by the processing circuitry, based on the combined exponent scaling factor and the exponent adjustment. In some embodiments, block 640 corresponds to operations performed by second adder 286 in FIG. 2B. In some embodiments, block 630 corresponds to the operations at stage 344 in FIG. 3B or stages 438, 443, and 444 in FIG. 4B.

In some embodiments, in a case that the first set of numbers and the second set of numbers are based on an MX integer format (e.g., MXINT8 or MXINT4), the unbiased exponent is obtained based on addition of the combined exponent scaling factor and the exponent adjustment, and the combined exponent scaling factor is an unbiased exponent value. In some embodiments, in a case that the first set of numbers and the second set of numbers are based on an MX floating point format (e.g., MXFP8, MXFP6, or MXFP4), the unbiased exponent of the numerical data is obtained based on addition of a maximum product exponent of the first set of quantized digital representations and the second set of quantized digital representations, the combined exponent scaling factor, and the exponent adjustment, the maximum product exponent is an unbiased exponent value, and the combined exponent scaling factor is another unbiased exponent value.

At block 650, the de-quantized digital representation of the numerical data is output. In some embodiments, the digital representation includes the mantissa of the mantissa of the digital representation, and an exponent of the de-quantized digital representation based on the unbiased exponent of the numerical data. In some embodiments, block 650 corresponds to operations performed by data format converter 290 in FIG. 2B. In some embodiments, block 630 corresponds to the operations at stage 346 in FIG. 3B or stage 446 in FIG. 4B.

FIG. 7 is a block diagram of a computing device example 700 usable in conjunction with one or more embodiments, in accordance with some embodiments. In some embodiments, methods and/or operations described in this disclosure with respect to FIGS. 3A-6 are in whole or in part implementable based on computing device 700, in accordance with some embodiments.

In some embodiments, computing device 700 is a general-purpose computing device or a specialized computing device. In some embodiments, computing device 700 includes one or more hardware processors 702 and a memory 704. In some embodiments, memory 704 includes non-transitory, computer-readable storage medium that, amongst other things, is encoded with, i.e., stores a set of executable instructions 706 (i.e., computer program codes). Execution of instructions 706 by one or more hardware processors 702 represents (at least in part) a processing device which implements a portion or all of the methods and/operations described herein in accordance with one or more embodiments (hereinafter, the noted processes and/or methods). In some embodiments, in addition to computer executable instructions 706, memory 704 also stores processing information 707 which facilitates performing a portion or all of the noted processes and/or methods.

One or more hardware processors 702 is electrically coupled with memory 704 via a bus 708. One or more hardware processors 702 is also electrically coupled with an I/O interface 710 by bus 708. A network interface 712 is also electrically connected to one or more hardware processors 702 via bus 708. Network interface 712 is connected to a network 714 (which is not part of computing device 700 in some embodiments), so that one or more hardware processors 702 and memory 704 are capable of connecting to external elements via network 714. One or more hardware processors 702 are configured to execute instructions 706 encoded in memory 704 in order to cause computing device 700 to be usable for performing a portion or all of the noted processes and/or methods described in this disclosure. In one or more embodiments, One or more hardware processors includes a CPU, a GPU, a TPU, an ASIC, a suitable processing circuitry, or any combination thereof.

In one or more embodiments, memory 704 includes an electronic, magnetic, optical, electromagnetic, infrared, and/or a semiconductor system (or apparatus or device). For example, memory 704 includes a semiconductor or solid-state memory, a magnetic tape, a removable computer diskette, a random access memory (RAM), a read-only memory (ROM), a rigid magnetic disk, and/or an optical disk. In one or more embodiments using optical disks, memory 704 includes a compact disk-read only memory (CD-ROM), a compact disk-read/write (CD-R/W), and/or a digital video disc (DVD).

In some embodiments, network interface 712 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented based on two or more computing devices 700.

Computing device 700 is configured to receive information through I/O interface 710. The information received through I/O interface 710 includes one or more of instructions, weight data, activation data, initialization information for neural network models, and/or other parameters for processing by one or more hardware processors 702. The information is transferred to one or more hardware processors 702 via bus 708. Computing device 700 is configured to implement a user interface (UI) based on executing user interface (UI) instructions 742 stored on memory 704. Computing device 700 is configured to receive user input based on user operations on the UI through I/O interface 910.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

In some aspects, a processing device for numerical data quantization includes a memory and processing circuitry coupled with the memory. In some embodiments, the processing circuitry is configured to determine a maximum exponent from a set of exponents of a set of digital representations of a set of numbers; obtain a set of scaled exponents based on subtraction of the maximum exponent from each one of the set of exponents; and perform one of: (i) obtain a set of quantized significands based on a set of mantissas of the set of digital representations of the set of numbers and the set of scaled exponents, or (ii) obtain a set of quantized mantissas based on the set of mantissas. In some embodiments, the processing circuitry is configured to output, to the memory, a set of quantized digital representations of the set of numbers, based on the set of quantized significands, or based on the set of quantized mantissas and the set of scaled exponents; and output, to the memory, a biased exponent scaling factor associated with the set of quantized digital representations based on the maximum exponent.

In some aspects, a processing device for numerical data de-quantization includes a memory and processing circuitry coupled with the memory. In some embodiments, the processing circuitry is configured to extract a mantissa of a de-quantized digital representation of a numerical data that is a result of processing a first set of quantized digital representations of a first set of numbers and a second set of quantized digital representations of a second set of numbers; extract an exponent adjustment from the numerical data; obtain a combined exponent scaling factor based on a first exponent scaling factor associated with the first set of quantized digital representations and a second exponent scaling factor associated with the second set of quantized digital representations; obtain an unbiased exponent of the numerical data based on the combined exponent scaling factor and the exponent adjustment; and output, to the memory, the de-quantized digital representation of the numerical data. In some embodiments, the de-quantized digital representation includes the mantissa of the de-quantized digital representation, and an exponent of the de-quantized digital representation based on the unbiased exponent of the numerical data.

In some aspects, a method of numerical data quantization includes determining a maximum exponent from a set of exponents of a set of digital representations of a set of numbers; obtaining, by processing circuitry, a set of scaled exponents based on subtraction of the maximum exponent from each one of the set of exponents; and performing, by the processing circuitry, one of: (i) obtaining a set of quantized significands based on a set of mantissas of the set of digital representations of the set of numbers and the set of scaled exponents, or (ii) obtaining a set of quantized mantissas based on the set of mantissas. In some embodiments, the method includes outputting a set of quantized digital representations of the set of numbers, based on the set of quantized significands, or based on the set of quantized mantissas and the set of scaled exponents; and outputting a biased exponent scaling factor associated with the set of quantized digital representations based on the maximum exponent.

In some aspects, a method of numerical data de-quantization includes extracting a mantissa of a de-quantized digital representation of a numerical data that is a result of processing a first set of quantized digital representations of a first set of numbers and a second set of quantized digital representations of a second set of numbers; extracting an exponent adjustment from the numerical data; obtaining, by processing circuitry, a combined exponent scaling factor based on a first exponent scaling factor associated with the first set of quantized digital representations and a second exponent scaling factor associated with the second set of quantized digital representations; obtaining, by the processing circuitry, an unbiased exponent of the numerical data based on the combined exponent scaling factor and the exponent adjustment; and outputting the de-quantized digital representation of the numerical data. In some embodiments, the de-quantized digital representation includes the mantissa of the mantissa of the digital representation, and an exponent of the de-quantized digital representation based on the unbiased exponent of the numerical data.

In some aspects, a processing device for numerical data quantization includes a maximum finder configured to determine a maximum exponent from a set of exponents of a set of digital representations of a set of numbers; a subtractor configured to obtain a set of scaled exponents based on subtraction of the maximum exponent from each one of the set of exponents; and a significand generator configured (i) to obtain a set of quantized significands based on a set of mantissas of the set of digital representations of the set of numbers and the set of scaled exponents, or (ii) to obtain a set of quantized mantissas based on the set of mantissas. In some embodiments, the processing device includes a data format converter configured to output a set of quantized digital representations of the set of numbers, based on the set of quantized significands, or based on the set of quantized mantissas and the set of scaled exponents, and output a biased exponent scaling factor associated with the set of quantized digital representations based on the maximum exponent.

In some aspects, a processing device for numerical data de-quantization includes a mantissa extractor configured to extract a mantissa of a de-quantized digital representation of a numerical data that is a result of processing a first set of quantized digital representations of a first set of numbers and a second set of quantized digital representations of a second set of numbers; an exponent adjustment extractor configured to extract an exponent adjustment from the numerical data; a first adder configured to obtain a combined exponent scaling factor based on a first exponent scaling factor associated with the first set of quantized digital representations and a second exponent scaling factor associated with the second set of quantized digital representations; a second adder configured to obtain an unbiased exponent of the numerical data based on the combined exponent scaling factor and the exponent adjustment; and a data format converter configured to output the de-quantized digital representation of the numerical data. In some embodiments, the de-quantized digital representation includes the mantissa of the de-quantized digital representation, and an exponent of the de-quantized digital representation based on the unbiased exponent of the numerical data.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure and that they may make various changes, substitutions, and alterations herein without departing from the spirit and scope of the present disclosure.

What is claimed is:

1. A processing device for numerical data quantization, comprising:
a memory; and
processing circuitry coupled with the memory and configured to:
determine a maximum exponent from a set of exponents of a set of digital representations of a set of numbers;
obtain a set of scaled exponents based on subtraction of the maximum exponent from each one of the set of exponents;
perform one of:
obtain a set of quantized significands based on a set of mantissas of the set of digital representations of the set of numbers and the set of scaled exponents, or
obtain a set of quantized mantissas based on the set of mantissas;
output, to the memory, a set of quantized digital representations of the set of numbers, based on the set of quantized significands, or based on the set of quantized mantissas and the set of scaled exponents; and
output, to the memory, a biased exponent scaling factor associated with the set of quantized digital representations based on the maximum exponent.

2. The processing device of claim 1, wherein the processing circuitry configured to obtain the set of quantized significands is further configured to:
obtain a set of shifted significands based on the set of mantissas and the set of scaled exponents; and
round the set of shifted significands to a target bit-length to become the set of quantized significands.

3. The processing device of claim 2, wherein the processing circuitry configured to obtain the set of quantized significands is further configured to:
convert the set of mantissas to a set of significands based on restoration of a first non-zero significand digit to each one of the set of mantissas; and
right-shift the set of significands by corresponding numbers of bits indicated by the set of scaled exponents to become the set of shifted significands.

4. The processing device of claim 2, wherein
the target bit-length is 7 bits.

5. The processing device of claim 1, wherein the set of quantized digital representations comprises:
a set of two's complement integer values of the set of quantized significands based on a set of sign bits of the set of digital representations of the set of numbers.

6. The processing device of claim 5, wherein
a bit-length of each one of the set of two's complement integer values is 8 bits.

7. The processing device of claim 1, wherein the processing circuitry configured to obtain the set of scaled exponents is further configured to:
obtain an unbiased exponent scaling factor based on subtraction of a target offset from the maximum exponent; and
obtain the set of scaled exponents based on subtraction of the unbiased exponent scaling factor from each one of the set of exponents, each exponent of the set of scaled exponents having a target exponent bit-length.

8. The processing device of claim 7, wherein
the target exponent bit-length ranges from 5 bits to 2 bits.

9. The processing device of claim 1, wherein the processing circuitry configured to obtain the set of quantized mantissas is further configured to:
round the set of mantissas to a target mantissa bit-length to become the set of quantized mantissas.

10. The processing device of claim 9, wherein
the target mantissa bit-length ranges from 3 bits to 1 bit.

11. The processing device of claim 1, wherein each one of the set of quantized digital representations comprises:
a corresponding one of a set of sign bits of the set of digital representations of the set of numbers;
a corresponding one of the set of scaled exponents; and
a corresponding one of the set of quantized mantissas.

12. The processing device of claim 11, wherein
a bit-length of each one of the set of quantized digital representations is 8 bits, a bit-length of each one of the set of scaled exponents is 4 bits, and a bit-length of each one of the set of quantized mantissas is 3 bits;
the bit-length of each one of the set of quantized digital representations is 8 bits, the bit-length of each one of the set of scaled exponents is 5 bits, and the bit-length of each one of the set of quantized mantissas is 2 bits;
the bit-length of each one of the set of quantized digital representations is 6 bits, the bit-length of each one of the set of scaled exponents is 2 bits, and the bit-length of each one of the set of quantized mantissas is 3 bits;
the bit-length of each one of the set of quantized digital representations is 6 bits, the bit-length of each one of the set of scaled exponents is 3 bits, and the bit-length of each one of the set of quantized mantissas is 2 bits; or
the bit-length of each one of the set of quantized digital representations is 4 bits, the bit-length of each one of the set of scaled exponents is 2 bits, and the bit-length of each one of the set of quantized mantissas is 1 bits.

13. The processing device of claim 1, wherein
a bit-length of the biased exponent scaling factor is 8 bits.

14. A processing device for numerical data de-quantization, comprising:
a memory; and
processing circuitry coupled with the memory and configured to:
extract a mantissa of a de-quantized digital representation of a numerical data that is a result of processing a first set of quantized digital representations of a first set of numbers and a second set of quantized digital representations of a second set of numbers;
extract an exponent adjustment from the numerical data;
obtain a combined exponent scaling factor based on a first exponent scaling factor associated with the first set of quantized digital representations and a second exponent scaling factor associated with the second set of quantized digital representations;
obtain an unbiased exponent of the numerical data based on the combined exponent scaling factor and the exponent adjustment; and
output, to the memory, the de-quantized digital representation of the numerical data, the de-quantized digital representation including
the mantissa of the de-quantized digital representation, and
an exponent of the de-quantized digital representation based on the unbiased exponent of the numerical data.

15. The processing device of claim 14, wherein the processing circuitry is further configured to:
identify a first non-zero significand digit of the numerical data,
wherein
the mantissa is extracted further based on removal of the first non-zero significand digit from the numerical data, and
the exponent adjustment is extracted further based on a digit position of the first non-zero significand digit within the numerical data.

16. The processing device of claim 14, wherein
the unbiased exponent is obtained based on addition of the combined exponent scaling factor and the exponent adjustment, and
the combined exponent scaling factor is an unbiased exponent value.

17. The processing device of claim 14, wherein
the unbiased exponent of the numerical data is obtained based on addition of a maximum product exponent of the first set of quantized digital representations and the second set of quantized digital representations, the combined exponent scaling factor, and the exponent adjustment,
the maximum product exponent is an unbiased exponent value, and
the combined exponent scaling factor is another unbiased exponent value.

18. A method of numerical data quantization, comprising:
determining a maximum exponent from a set of exponents of a set of digital representations of a set of numbers;
obtaining, by processing circuitry, a set of scaled exponents based on subtraction of the maximum exponent from each one of the set of exponents;
performing, by the processing circuitry, one of:
obtaining a set of quantized significands based on a set of mantissas of the set of digital representations of the set of numbers and the set of scaled exponents, or
obtaining a set of quantized mantissas based on the set of mantissas;
outputting a set of quantized digital representations of the set of numbers, based on the set of quantized significands, or based on the set of quantized mantissas and the set of scaled exponents; and
outputting a biased exponent scaling factor associated with the set of quantized digital representations based on the maximum exponent.

19. The method of claim 18, wherein the obtaining the set of quantized significands comprises:
obtaining a set of shifted significands based on the set of mantissas and the set of scaled exponents; and
rounding the set of shifted significands to a target bit-length to become the set of quantized significands.

20. The method of claim 18, wherein the obtaining the set of scaled exponents comprises:
obtaining an unbiased exponent scaling factor based on subtraction of a target offset from the maximum exponent; and
obtaining the set of scaled exponents based on subtraction of the unbiased exponent scaling factor from each one of the set of exponents, each exponent of the set of scaled exponents having a target exponent bit-length.
